(19) United States
(12) Patent Application Publication
(10) Pub. No.: US 2023/0317947 A1
(43) Pub. Date: Oct. 5, 2023

(54) POSITIVE ELECTRODE FOR RECHARGEABLE LITHIUM BATTERY AND RECHARGEABLE LITHIUM BATTERY INCLUDING THE SAME

(71) Applicant: SAMSUNG SDI CO., LTD., Yongin-si (KR)

(72) Inventors: Tae Jin LEE, Yongin-si (KR); Myungheui WOO, Yongin-si (KR); Sanghoon KIM, Yongin-si (KR); Arum YU, Yongin-si (KR)

(21) Appl. No.: 18/194,450

(22) Filed: Mar. 31, 2023

(30) Foreign Application Priority Data
Apr. 1, 2022 (KR) 10-2022-0041243
Aug. 18, 2022 (KR) 10-2022-0103569

(51) Int. Cl. H01M 4/60; H01M 4/525; H01M 4/131

(52) U.S. Cl. CPC H01M 4/60; H01M 4/525; H01M 4/131; H01M 2004/028

(57) ABSTRACT

Disclosed are a positive electrode for a rechargeable lithium battery and a rechargeable lithium battery including the same. For example, one or more embodiments provide a positive electrode for a rechargeable lithium battery including a positive electrode current collector and a positive electrode active material layer on one surface or two opposing surfaces of the positive electrode current collector, wherein the positive electrode active material layer includes a metal organic framework of ZIF-8, MOF-177, HKUST-1, Fe-BTC, or a combination thereof; and a positive electrode active material that is a nickel-based oxide.

### CROSS-REFERENCE TO RELATED APPLICATION

This application claims priority to and the benefit of Korean Patent Application No. 10-2022-0041243 filed in the Korean Intellectual Property Office on Apr. 1, 2022, and Korean Patent Application No. 10-2022-0103569 filed in the Korean Intellectual Property Office on Aug. 18, 2022, the entire contents of each of which are hereby incorporated by reference.

### BACKGROUND

### 1. Field

Example embodiments of the present disclosure are related to a positive electrode for a rechargeable lithium battery and a rechargeable lithium battery including the same.

### 2. Description of the Related Art

Rechargeable lithium batteries are in the spotlight as power sources for driving medium to large devices such as hybrid vehicles and battery vehicles as well as small devices such as, for example, mobile phones, notebook computers, and smart phones.

When these rechargeable lithium batteries are exposed to misuse conditions such as, for example, overcharging and/or the like and/or extreme conditions such as heat exposure and/or the like, thermal runaway can occur, because an amount of gas generated thereinside sharply increases, and thus, the rechargeable lithium batteries may explode.

A method of reducing the amount of generated gas by coating the surface of an active material or by adding a film-forming additive to an electrolyte can be accomplished to some extent. However, such methods are no longer effective when the rechargeable lithium batteries enter a thermal runaway situation due to a short circuit.

### SUMMARY

One or more embodiments of the present disclosure suppress or reduce a rapid increase of an amount of gas generated in a rechargeable lithium battery when it enters a thermal runaway situation.

In one or more embodiments, a positive electrode for a rechargeable lithium battery includes a positive electrode current collector and a positive electrode active material layer on one surface or two opposing surfaces of the positive electrode current collector, wherein the positive electrode active material layer includes a metal organic framework (MOF) of ZIF-8, MOF-177, HKUST-1, Fe-BTC, or a combination thereof; and a positive electrode active material that is a nickel-based oxide.

The positive electrode active material that is a nickel-based oxide, may include a lithium composite oxide represented by Chemical Formula 1:

LiₐNiₓM¹_{y}M²_{z}O_{2+b} Chemical Formula 1

In Chemical Formula 1, 0.9≤a≤1.3, 0.3≤x≤1, 0≥y≥0.7, 0≤z≤0.1, x+y+z=1, −0.1≤b≤0.1, M¹ is at least one element selected from Co, Mn, or Al, and M² is at least one element selected from Al, B, Ce, Co, Cr, F, Mg, Mn, Mo, Nb, P, S, Ti, V, W, or Zr.

Another embodiment provides a rechargeable lithium battery including the positive electrode for the rechargeable lithium battery.

In the positive electrode for a rechargeable lithium battery of one or more embodiments, the metal organic framework is a material capable of effectively trapping gas through an adsorption reaction.

Accordingly, even if a rechargeable lithium battery including the positive electrode for a rechargeable lithium battery of one or more embodiments enters a thermal runaway situation and an amount of gas generated therein rapidly increases, the metal organic framework traps the rapidly increasing gas and thus the risk of explosion is significantly lowered.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 illustrates various shapes (patterns) of a positive electrode active material layer formed according to one or more embodiments.

FIG. 2 is a perspective view of a pouch-type rechargeable battery according to one or more embodiments.

FIG. 3 is a vertical cross-sectional view taken along the line I-I in FIG. 2 in the direction of the arrow.

FIG. 4 is a horizontal cross-sectional view taken along the line II-II in FIG. 2 in the direction of the arrow.

FIG. 5 is an evaluation of the amount of gas generated during formation charging and discharging for rechargeable lithium battery cells of examples and comparative examples.

FIG. 6 is an evaluation of the amount of gas generated at the time of overcharging with respect to the rechargeable lithium battery cells of examples and comparative examples.

FIG. 7 is an evaluation of the amount of gas generated when exposed to heat for the rechargeable lithium battery cells of examples and comparative examples.

FIG. 8 is an evaluation of the amount of gas generated during formation charging and discharging for each content of the metal organic framework in the positive electrode active material layer for the rechargeable lithium battery of examples and a comparative example.

FIG. 9 illustrates the evaluation of the amount of gas generated during overcharge for each content of the metal organic frameworks in the positive electrode active material layers for the rechargeable lithium battery cells of examples and a comparative example.

FIG. 10 illustrates the evaluation of the amount of gas generated upon heat exposure for each content of the metal organic frameworks in the positive electrode active material layers for the rechargeable lithium battery cells of examples and a comparative example.

### DETAILED DESCRIPTION

Hereinafter, example embodiments will be described in more detail so that those of ordinary skill in the art can easily implement them. However, the subject matter of this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

The term “combination thereof” refers to a mixture, a laminate, a composite, a copolymer, an alloy, a blend, a reaction product, and/or the like of constituents.

It should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., may be exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The term “layer” includes not only a shape formed on the whole surface when viewed from a plan view, but also a shape formed on a partial surface.

The term “particle diameter” or “average particle diameter” may be measured by any suitable method generally used in the art, for example, may be measured by a particle size analyzer, and/or may be measured by a transmission electron micrograph or a scanning electron micrograph. In some embodiments, it is possible to obtain an average particle diameter value by measuring using a dynamic light scattering method, performing data analysis, counting the number of particles for each particle size range, and calculating from this. Unless otherwise defined, the average particle diameter may mean a diameter (D50) of particles having a cumulative volume of 50 volume % in the particle size distribution.

The term “thickness” may be measured through an image (e.g., a photograph) taken with a thickness meter, an optical microscope, and/or a scanning electron microscope (SEM).

Positive Electrode for Rechargeable Lithium Battery

In one or more embodiments, a positive electrode for a rechargeable lithium battery includes a positive electrode current collector and a positive electrode active material layer on one surface or both surfaces of the positive electrode current collector, wherein the positive electrode active material layer includes a metal organic framework of zeolitic imidazolate framework 8 (ZIF-8), metal organic framework 177 (MOF-177), Hong Kong University of Science and Technology 1 (HKUST-1, or metal organic framework 199 (MOF-199)), iron-based metal organic framework (Fe-BTC), or a combination thereof; and a positive electrode active material that is a nickel-based oxide:

The metal organic framework is a material capable of effectively trapping gas through an adsorption reaction. Accordingly, even if a rechargeable lithium battery including the positive electrode for a rechargeable lithium battery of one or more embodiments enters a thermal runaway situation and an amount of gas generated therein rapidly increases, the metal organic framework traps the rapidly increasing gas and thus the risk of explosion is significantly lowered.

Hereinafter, the positive electrode for a rechargeable lithium battery of one or more embodiments will be described in more detail.

Structure of Metal Organic Framework

The metal organic framework is a material in which clusters including metal ions or metals (e.g., metal atoms) are connected by organic ligands, and is a type (or kind) of coordination polymer. The metal organic framework has a cage that is an empty space therein by forming a three-dimensional structure. As a result, the metal organic framework may undergo an adsorption reaction through the cage and trap gas into the cage.

On the other hand, zeolite, which is a crystalline aluminum silicate mineral, has an inferior gas trapping effect, compared with the metal organic framework. The gas adsorption reaction is a reaction in which gas molecules are adsorbed on the surface of a cage inside the material structure. In general, the larger a specific surface area, the more gas molecules may be adsorbed. According to the results of several previous studies, which compare specific surface areas of zeolite and representative materials with the metal organic framework, the metal organic framework has been reported to have a larger specific surface area than that of the zeolite. Accordingly, the metal organic framework may have a larger surface area for gas adsorption than the zeolite. For example, in a rechargeable lithium battery using a nickel-based positive electrode active material including 90% or more of Ni as a positive electrode active material, the metal organic framework exhibits a very excellent gas trapping effect, but the zeolite exhibits a very inferior gas trapping effect. This fact is confirmed in evaluation examples further described herein below.

Structural and compositional characteristics of the metal organic framework may be usefully utilized in formation charging and discharging and thermal runaway situations of a rechargeable lithium battery. For example, when the positive electrode for a rechargeable lithium battery according to one embodiment is inside the rechargeable lithium battery, an increase in battery volume and an increase in internal pressure may be prevented or reduced by trapping gas generated inside the rechargeable lithium battery during the first cycle charge and discharge (e.g., formation charge and discharge). Furthermore, even when the rechargeable lithium battery enters a thermal runaway situation where a short circuit occurs due to overcharge, heat exposure, and/or the like, the metal organic framework may effectively collect gas components (e.g., H₂, CO, CO₂, and/or the like) rapidly increasing inside the rechargeable lithium battery, so that the rechargeable lithium battery may be significantly less likely to explode.

For example, in the positive electrode for a rechargeable lithium battery of one or more embodiments, the metal organic framework may include ZIF-8, MOF-177, HKUST-1, Fe-BTC, or a combination thereof, and each structure is as follows:

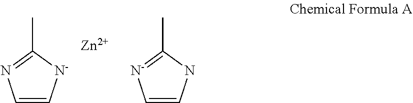

The ZIF-8 is represented by Chemical Formula A, the coordination metal is Zn, and the linker is 2-methylimidazole. The ZIF-8 has a pore volume of about 0.66 cm³/g and a BET specific surface area of about 1300 to about 1800 m²/g.

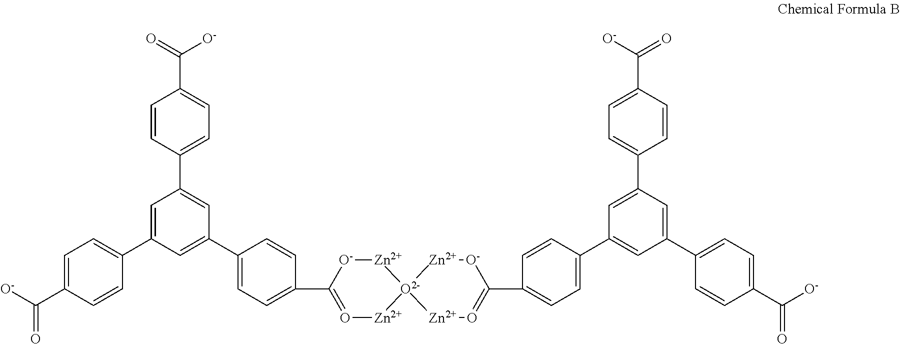

The MOF-177 is represented by Chemical Formula B, the coordination metal is Zn, and the linker is benzene-1,3,5-tribenzoic acid (H3BTB). The MOF-177 has a pore volume of about 1.6 g/cm³ and a BET specific surface area of about 3800 to about 4000 m²/g.

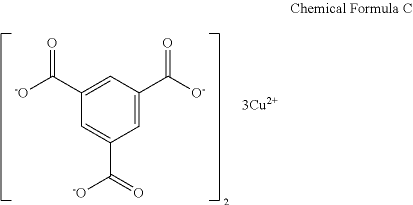

The HKUST-1 is also called Cu-BTC, is represented by Chemical Formula C, the coordination metal is Cu, and the linker is 1,3,5-benzenetricarboxylic acid. The HKUST-1 has a pore volume of about 0.33 g/cm³ and a BET specific surface area of about 1500 to about 2100 m²/g.

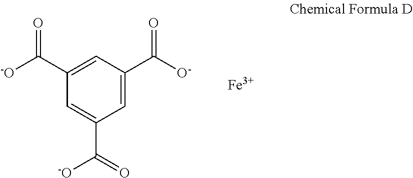

The Fe-BTC is represented by Chemical Formula D, the coordination metal is Fe, and the linker is 1,3,5-benzenetricarboxylic acid. The Fe-BTC has a pore volume of 0.9 g/cm³ and a BET specific surface area of about 1300 to about 1600 m²/g.

The ZIF-8, MOF-177, HKUST-1, and Fe-BTC each include Zn, Cu, or Fe as a coordination metal, and have excellent gas trapping effect compared to a metal organic framework containing Ni or Al as a coordination metal. This is due to a strong increase in polarity in the ionized forms (e.g., Zn²⁺, Cu²⁺, or Fe³⁺) of the coordination metals in ZIF-8, MOF-177, HKUST-1 and Fe-BTC, and is supported by the evaluation examples described below.

MOF Content in the Positive Electrode Active Material Layer

The content of the metal organic framework based on the total amount (100 wt %) of the positive electrode active material layer may be about 0.1 wt % to about 40 wt %. For example, the content of the metal organic framework based on the total amount (100 wt %) of the positive electrode active material layer may be greater than or equal to about 0.1 wt %, greater than or equal to about 0.5 wt %, greater than or equal to about 1 wt %, or greater than or equal to about 5 wt % and less than or equal to about 40 wt % or less than or equal to about 30 wt %.

When the content of the metal organic framework based on the total amount (100 wt %) of the positive electrode active material layer is less than about 0.1 wt %, the gas trapping effect by the metal organic framework may be insignificant. On the other hand, when the content of the metal organic framework is more than about 40 wt %, a content of the positive electrode active material is relatively decreased, so that the cycle-life of the rechargeable lithium battery may be sharply reduced during the charging and discharging process.

Types (or Kinds) of Positive Electrode Active Material

The positive electrode active material that is a nickel-based oxide may include a lithium composite oxide represented by Chemical Formula 1:

LiₐNiₓM¹_{y}M²_{z}O_{2+b}. Chemical Formula 1

In Chemical Formula 1, 0.9≤a≤1.3, 0.3≤x≤1, 0≤y≤0.7, 0≤z≤0.1, x+y+z=1, −0.1≤b≤0.1, M¹ is at least one element selected from Co, Mn, or Al, and M² is at least one element selected from Al, B, Ce, Co, Cr, F, Mg, Mn, Mo, Nb, P, S, Ti, V, W, or Zr.

At least one of the nickel-based positive electrode active material represented by Chemical Formula 1 may be included.

In one or more embodiments, the positive electrode active material layer may include an NCM-based positive electrode active material that is a composite oxide of nickel, cobalt, manganese, and lithium. The NCM-based positive electrode active material may be one that in Chemical Formula 1, M¹ includes Co and Mn; M² is at least one element selected from Al, B, Ce, Cr, F, Mg, Mo, Nb, P, S, Ti, V, W, or Zr; 0.9≤a≤1.2, 0.9≤a≤1.2, or 0.9≤a≤1.1; 0.7≤x≤1, 0.8≤x≤1, or 0.9≤x≤1; 0<y≤0.3, 0<y≤0.2, or 0<y≤0.2; and 0≤z≤0.1.

In addition, the positive electrode active material layer may include an NCA-based positive electrode active material that is a composite oxide of nickel, cobalt, and aluminum and lithium. The NCA-based positive electrode active material may be one that in Chemical Formula 1, M¹ includes Co and Al; M² is at least one element selected from B, Ce, Cr, F, Mg, Mn, Mo, Nb, P, S, Ti, V, W, or Zr; 0.9≤a≤1.2, 0.9≤a≤1.2, or 0.9≤a≤1.1; 0.7≤x≤1, 0.8≤x≤1, or 0.9≤x≤1; 0<y≤0.3, 0<y≤0.2, or 0<y≤0.2; and 0≤z≤0.1.

In addition, the positive electrode active material layer may include a NiMn-based positive electrode active material that is a composite oxide of nickel and manganese and lithium. The NiMn-based positive electrode active material is a so-called Co-free positive electrode active material (e.g., a positive electrode active material that does not include cobalt), wherein M¹ includes Mn; M² is at least one element selected from Al, B, Ce, Cr, F, Mg, Mo, Nb, P, S, Ti, V, W or Zr; 0.9≤a≤1.3, 0.9≤a≤1.2, or 0.9≤a≤1.1; 0.5≤x≤1, 0.6≤x≤1, 0.7≤x≤1, 0.8≤x≤1, or 0.9≤x≤1; 0<y≤0.5, 0<y≤0.4, 0<y≤0.3, 0<y≤0.2, or 0<y≤0.1; and 0≤z≤0.1.

In each of the NCM-based positive electrode active material, the NCA-based positive electrode active material, and the NiMn-based positive electrode active material, M² is a dopant and partially modifies the lattice structure of each of the positive electrode active materials to improve reversible intercalation and deintercalation of lithium.

When the positive electrode active material represented by Chemical Formula 1 is used, it may be adjusted suitably or appropriately by considering the gas trapping effect by the metal organic framework, which is ZIF-8, MOF-177, HKUST-1, Fe-BTC, or a combination thereof, and battery cycle-life by the positive electrode active material comprehensively.

For example, in the case of using the NCM-based positive electrode active material, the NCA-based positive electrode active material, the NiMn-based positive electrode active material, or a combination thereof, as the nickel content in the positive electrode active material increases, during the driving of the rechargeable lithium battery, the amount of gas generated from the positive electrode increases. Even in this case, the metal organic framework, which is ZIF-8, MOF-177, HKUST-1, Fe-BTC, or a combination thereof, may effectively trap gas.

For example, as the positive electrode active material, LiNi_{0.91}Co_{0.07}Al_{0.02}O₂ used in examples to be further described herein below as a type (or kind) of the NCA-based positive electrode active material may be used.

Content of Positive Electrode Active Material in the Positive Electrode Active Material Layer

A content of the positive electrode active material based on the total amount (100 wt %) of the positive electrode active material layer may be about 55 wt % to about 98 wt %. For example, the content of the positive electrode active material based on the total amount of the positive electrode active material layer may be greater than or equal to about 55 wt %, greater than or equal to about 60 wt %, greater than or equal to about 65 wt %, or greater than or equal to about 70 wt %, and less than or equal to about 98 wt %, less than or equal to about 95 wt %, or less than or equal to about 90 wt %.

Within the above range, comprehensively considering the gas trapping effect by the metal organic framework, which is the ZIF-8, MOF-177, HKUST-1, Fe-BTC, or a combination thereof, and the battery cycle-life of the positive electrode active material, it may be suitably or appropriately adjusted

Additional Components of Positive Electrode Active Material Layer

The positive electrode active material layer may further include an additional positive electrode active material, a binder, a conductive material (e.g., an electrically conductive material), or a combination thereof, in addition to the metal organic framework of ZIF-8, MOF-177, HKUST-1, Fe-BTC, or a combination thereof and the positive electrode active material represented by Chemical Formula 1.

For example, the positive electrode active material represented by Chemical Formula 1 may be included as a first positive electrode active material, and an additional positive electrode active material may be included as a second positive electrode active material.

As the second positive electrode active material, a compound capable of reversible intercalation and deintercalation of lithium (a lithiated intercalation compound) may be used. Examples of the positive electrode active material include a compound represented by any one selected from the following formulas:

LiₐA_{1-b}X_{b}D₂ (0.90≤a≤1.8, 0≤b≤0.5);

LiₐA_{1-b}X_{b}O_{2-c}D_{c} (0.90≤a≤1.8, 0≤b≤0.5, 0≤c≤0.05);

LiₐE_{1-b}X_{b}O_{2-c}D_{c} (0.90≤a≤1.8, 0≤b≤0.5, 0≤c≤0.05);

LiₐE_{2-b}X_{b}O_{4-c}D_{c} (0.90≤a≤1.8, 0≤b≤0.5, 0≤c≤0.05);

LiₐN_{1-b-c}Co_{b}X_{c}D_{α} (0.90≤a≤1.8, 0≤b≤0.5, 0≤c≤0.5, 0<α≤2);

LiₐNi_{1-b-c} Co_{b}X_{c}O_{2-α}T_{α} (0.90≤a≤1.8, 0≤b≤0.5, 0≤c≤0.05, 0<α<2);

LiₐNi_{1-b-c}Co_{b}X_{c}O_{2-α}T₂ (0.90≤a≤1.8, 0≤b≤0.5, 0≤c≤0.05, 0<α<2);

LiₐN_{1-b-c}Mn_{b}X_{c}D_{α} (0.90≤a≤1.8, 0≤b≤0.5, 0≤c≤0.05, 0<α≤2);

LiₐNi_{1-b-c}Mn_{b}X_{c}O_{2-α}T_{α} (0.90≤a≤1.8, 0≤b≤0.5, 0≤c≤0.05, 0<α<2);

LiₐN_{1-b-c}Mn_{b}X_{c}O_{2-α}T₂ (0.90≤a≤1.8, 0≤b≤0.5, 0≤c≤0.05, 0<α<2);

LiₐNi_{b}E_{c}G_{d}O₂ (0.90≤a≤1.8, 0≤b≤0.9, 0≤c≤0.5, 0.001≤d≤0.1);

LiₐNi_{b}Co_{c}Mn_{d}GeO₂ (0.90≤a≤1.8, 0≤b≤0.9, 0≤c≤0.5, 0≤d≤0.5, 0.001≤e≤0.1);

LiₐNiG_{b}O₂ (0.90≤a≤1.8, 0.001≤b≤0.1);

LiaCOGbO₂ (0.90≤a≤1.8, 0.001≤b≤0.1);

LiₐMn_{1-b}GbO₂ (0.90≤a≤1.8, 0.001≤b≤0.1);

LiₐMn₂GbO₄ (0.90≤a≤1.8, 0.001≤b≤0.1);

LiₐMn_{1-g}G_{g}PO₄ (0.90≤a≤1.8, 0≤g≤0.5);

QO₂; QS₂; LiQS₂;

V₂O₅; LiV₂O₅;

LiZO₂;

LiNiVO₄;

Li_{(3-f)}J₂(PO₄)₃ (0≤f≤2);

Li_{(3-f)}Fe₂(PO₄)₃ (0≤f≤2);

LiₐFePO₄ (0.90≤a≤1.8).

In the above chemical formulas, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The compounds may have a coating layer on the surface, or may be mixed together with another compound having a coating layer. The coating layer may include at least one coating element compound selected from the group consisting of an oxide of a coating element, a hydroxide of the coating element, an oxyhydroxide of the coating element, an oxycarbonate of the coating element, and a hydroxyl carbonate of the coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. The coating layer forming process may use a method that does not (or substantially does not) adversely affect the physical properties of the positive electrode active material, for example, spray coating, dipping, and/or the like.

As an example, the second positive electrode active material may include a lithium nickel cobalt composite oxide represented by Chemical Formula 12.

Liₐ₁₂Niₓ₁₂Co_{y12}M¹³_{1-x12-y12}O₂ Chemical Formula 12

In Chemical Formula 12, 0.9≤a≤12≤1.8, 0.3≤x≤12<1, 0<y12≤0.7, and M¹³ is selected from Al, B, Ce, Cr, F, Mg, Mn, Mo, Nb, P, S, Si, Sr, Ti, V, W, Zr, and a combination thereof.

In Chemical Formula 12, 0.3≤x12≤0.99 and 0.01≤y≤12≤0.7; 0.4≤x12≤0.99 and 0.01≤y≤12≤0.6; 0.5≤12≤0.99 and 0.01≤y12≤0.5; 0.6≤x12≤0.99 and 0.01≤y12≤0.4; 0.7≤x12≤0.99 and 0.01≤y12≤0.3; 0.8≤x12≤0.99 and 0.01≤y12≤0.2; or 0.9≤x12≤0.99 and 0.01≤y12≤0.1.

As an example, the second positive electrode active material may include a lithium nickel cobalt composite oxide represented by Chemical Formula 13.

Liₐ₁₃Niₓ₁₃Co_{y13}M¹⁴_{z13}M¹⁵_{1-x13-y13-z13}O₂ Chemical Formula 13

In Chemical Formula 13, 0.9≤a13≤1.8, 0.3≤x13≤0.98, 0.01≤y13≤0.69, 0.01≤z13≤0.69, M¹⁴ is selected from Al, Mn, and a combination thereof, and M¹⁵ is selected from B, Ce, Cr, F, Mg, Mo, Nb, P, S, Si, Sr, Ti, V, W, Zr, and a combination thereof.

In Chemical Formula 13, 0.4≤x13≤0.98, 0.01≤y13≤0.59, and 0.01≤z13≤0.59; 0.5≤x13≤0.98, 0.01≤y13≤0.49, and 0.01≤z13≤0.49; 0.6≤x13≤0.98, 0.01≤y13≤0.39, and 0.01≤z13≤0.39; 0.7≤x13≤0.98, 0.01≤y13≤0.29, and 0.01≤z13≤0.29; 0.8≤x13≤0.98, 0.01≤y13≤0.19, and 0.01≤z13≤0.19; or 0.9≤x13≤0.98, 0.01≤y13≤0.09, and 0.01≤z13≤0.09.

The second positive electrode active material may be represented by a chemical formula different from that of the first positive electrode active material.

When the second positive electrode active material is further included, a weight ratio of the first positive electrode active material and the second positive electrode active material may be about 5:5 to 9:1, about 6:4 to 9:1, or about 7:3 to 9:1.

The binder improves binding properties of positive electrode active material particles with one another and with a current collector. Examples thereof may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. The conductive material is used to impart conductivity (e.g., electrical conductivity) to the electrode, and any suitable material may be used as long as it does not cause a chemical change (e.g., an undesirable chemical change) in the battery to be configured and is an electron conductive material (e.g., an electrically conductive material). Examples of the conductive material may include a carbon-based material such as natural graphite, artificial graphite, carbon black, acetylene black, ketjen black, carbon fiber, carbon nanotube, and the like; a metal-based material of a metal powder and/or a metal fiber, and the like including copper, nickel, aluminum silver, and the like; a conductive polymer such as a polyphenylene derivative; or a mixture thereof.

Based on the total amount (100 wt %) of the positive electrode active material layer further including the binder and the conductive material, the metal organic framework may be included in an amount of about 0.05 wt % to about 40 wt %, about 0.05 wt % to about 30 wt %, about 0.1 wt % to about 30 wt %, about 0.1 wt % to about 20 wt %, about 0.1 wt % to about 10 wt %, about 0.1 wt % to about 5 wt %, about 0.1 wt % to about 3 wt %, about 0.1 wt % to about 2 wt %, about 0.1 wt % to about 1 wt %, or about 0.1 wt % to about 0.5 wt %, the positive electrode active material may be included in an amount of about 55 wt % to about 98 wt %, about 60 wt % to about 98 wt %, about 70 wt % to about 98 wt %, about 80 wt % to about 98 wt %, or about 85 wt % to about 95 wt %, the binder may be included in an amount of about 1 wt % to about 5 wt %, and the conductive material may be included in an amount of about 1 wt % to about 5 wt %. Herein, each content of the metal organic framework and the positive electrode active material may be adjusted with reference to the above description.

Thickness and Loading Amount of Positive Electrode Active Material Layer

The thickness of positive electrode active material layer may be about 1 to about 200 μm. For example, the thickness of the positive electrode active material layer may be greater than or equal to about 1 μm, greater than or equal to about 5 μm, greater than or equal to about 10 μm, or greater than or equal to about 50 μm and less than or equal to about 200 μm, less than or equal to about 150 μm, less than or equal to about 110 μm, or less than or equal to about 90 μm.

For reference, the term “thickness” may be measured through an image (e.g., a photograph) taken with a thickness meter, a scanning electron microscope (SEM), an optical microscope, and/or the like. Herein, when the binder is included in the coating layer, a thickness and an area of the coating layer includes a thickness and an area by the binder. For example, when the thickness of the coating layer in the separator is measured, the separator is cut in a thickness direction and then, measured with respect to a length between the bottom and the top of the coating layer by using a commercially available thickness meter. In some embodiments, after taking an image (e.g., a photograph) of the cut surface with an optical microscope such as a scanning electron microscope and the like, the length between bottom and top of the coating layer shown in the photograph may be calculated and used as the thickness of the coating layer.

On the other hand, the term “area” may be measured through the image (e.g., the photograph taken) by an optical microscope, a scanning electron microscope, and/or the like. For example, the area of the coating layer in the separator may be obtained by taking an image (e.g., a picture) of the separator from the top by using an optical microscope, a scanning electron microscope, and/or the like and measuring an area of the coating layer shown in the image (e.g., the photograph).

In addition, a loading amount of the positive electrode active material layer may be about 1 mg/cm² to about 80 mg/cm² per area of one surface of the positive electrode current collector. For example, the loading amount of the positive electrode active material layer may be greater than or equal to about 1 mg/cm², greater than or equal to about 3 mg/cm², greater than or equal to about 5 mg/cm², or greater than or equal to about 10 mg/cm² and less than or equal to about 80 mg/cm², less than or equal to about 50 mg/cm², less than or equal to about 30 mg/cm², or less than or equal to about 20 mg/cm² per area of one surface of the positive electrode current collector.

When the positive electrode active material layer has a thickness of less than about 1 μm, and the positive electrode active material layer has a loading amount of less than about 1 mg/cm², the gas trapping effect by the metal organic framework may be insignificant or undesirable. On the other hand, when the positive electrode active material layer has a thickness of greater than about 200 mg/cm², and the positive electrode active material layer has a loading amount of greater than about 80 mg/cm², charging density of the rechargeable lithium battery may be lowered.

Shape (Pattern) of Positive Electrode Active Material Layer

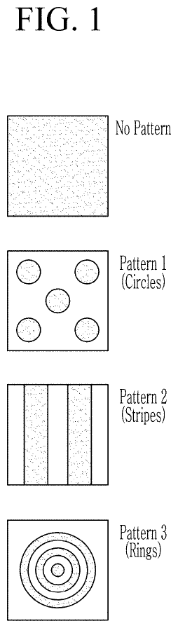

The positive electrode active material layer may be patterned. A gas diffusion area is increased in the patterned positive electrode active material layer, so that the gas trapping effect may be further increased. For example, FIG. 1 illustrates various shapes (patterns) of the positive electrode active material layer. The positive electrode active material layer may be patterned in the form of a plurality of circles, stripes, rings, or a combination thereof. However, embodiments of the present disclosure are not limited thereto, and may include an unpatterned positive electrode active material layer, and even in this case, an excellent gas trapping effect may be exhibited.

Method of Forming Positive Electrode Active Material Layer

A method of forming the positive electrode active material layer may be any suitable method used in the related art.

For example, the positive electrode active material; and the metal organic framework such as ZIF-8, MOF-177, HKUST-1, Fe-BTC, or a combination thereof; are dispersed in a suitable or appropriate solvent, preparing a coating solution in a slurry phase, wherein the binder and/or the conductive material may be added thereto. Subsequently, the coating solution is applied on the positive electrode current collector and then, dried, roll-pressed, etc. to form the positive electrode active material layer, thereby completing the positive electrode according to one embodiment.

The solvent may include any suitable solvent capable of dispersing the positive electrode active material; the metal organic framework such as ZIF-8, MOF-177, HKUST-1, Fe-BTC, or a combination thereof; the binder; and the conductive material without particular limitation, for example methylpyrrolidone (NMP) and/or the like.

In the coating solution, a total amount of solids (e.g., the positive electrode active material; the metal organic framework such as ZIF-8, MOF-177, HKUST-1, Fe-BTC, or a combination thereof; the binder; and the conductive material) is in a range of about 0.5 wt to about 30 wt %. Within the range, because dispersibility of the coating solution may be suitably or appropriately controlled, the coating solution may be uniformly (e.g., substantially uniformly) coated on the positive electrode current collector.

On the positive electrode current collector, a method of applying the coating solution is not particularly limited but may include any suitable method in the art without particular limitation. For example, any suitable method such as die coating, printing, compression, press-fitting, roller coating, blade coating, bristle coating, dipping coating, spray coating, flow-roll coating, and the like may be used.

Positive Electrode Current Collector

An aluminum foil may be used as the positive electrode current collector, but is not limited thereto.

Rechargeable Lithium Battery

Another embodiment provides a rechargeable lithium battery including the aforementioned positive electrode for a rechargeable lithium battery of one or more embodiments.

Even if a rechargeable lithium battery including the positive electrode for a rechargeable lithium battery of one or more embodiments enters a thermal runaway situation and an amount of gas generated therein rapidly increases, the metal organic framework traps the rapidly increasing gas and thus the risk of explosion is significantly lowered.

Hereinafter, the rechargeable lithium battery will be described in more detail, except for descriptions that overlap with the foregoing.

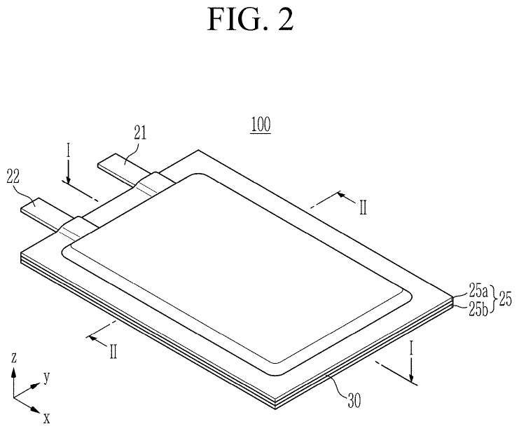

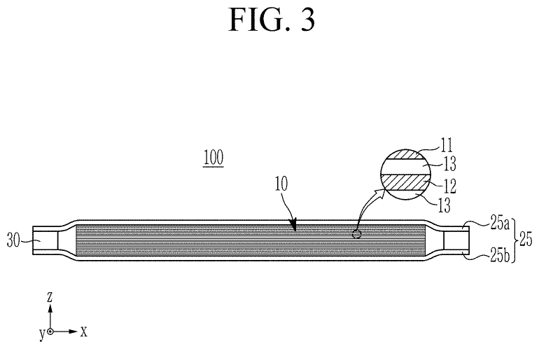

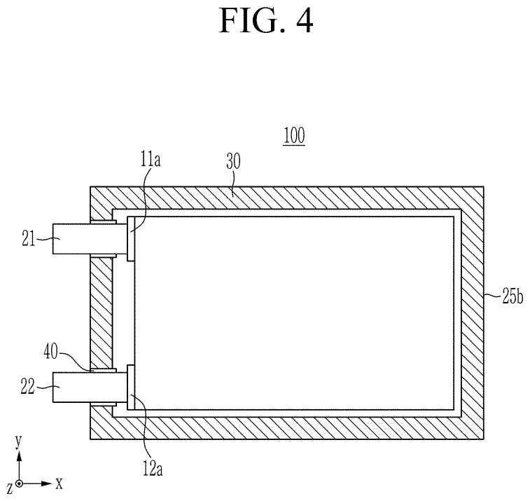

FIG. 2 is a perspective view of a pouch-type rechargeable battery according to one or more embodiments, FIG. 3 is a vertical cross-sectional view taken along the line I-I in FIG. 2 in the direction of the arrow, and FIG. 4 is a horizontal cross-sectional view taken along the line II-II in FIG. 2 in the direction of the arrow. Herein, the rechargeable lithium battery according to one or more embodiments is described as an example in which a stack-type electrode assembly is placed in a pouch-type case, but the present disclosure is not limited thereto. An electrode assembly such as a stack type (or kind), a winding type or kind (jelly roll type or kind), a stack-and-fold type (or kind), and a Z-fold type (or kind) may be applied to a battery in the case of a type (or kind) prepared to be cylindrical, prismatic, coin type (or kind), or the like.

Referring to FIGS. 2 to 4, the pouch-type rechargeable battery 100 according to one or more embodiments includes an electrode assembly 10 in which a separator 13 is interposed between the positive electrode 11 and the negative electrode 12, an electrode assembly 10 accommodated in an exterior material 25, a positive terminal 21 electrically connected to the positive electrode 11, and a negative terminal 22 electrically connected to the negative electrode 12.

In one or more embodiments, the electrode assembly 10 may have a structure in which a plurality of positive electrodes 11 and a plurality of negative electrodes 12 having a rectangular sheet shape are alternately stacked with a separator 13 interposed therebetween. Embodiments of the present disclosure are not limited thereto, and one positive electrode 11 and one negative electrode 12 may be stacked with one separator 13 interposed therebetween. In addition, the electrode assembly may have a structure in which a separator is interposed between a strip-shaped positive electrode and a negative electrode and then wound.

In the electrode assembly 10, a positive electrode uncoated region 11a and a negative electrode uncoated region 12a are at one end of the electrode assembly 10, the positive electrode terminal 21 is attached to the positive uncoated region 11a by welding, and the negative electrode terminal 22 is attached to the negative electrode uncoated region 12a by welding.

The positive electrode 11, the negative electrode 12, and the separator 13 may each have a rectangular sheet shape. The electrode assembly 10 may be accommodated in the exterior material 25 and sealed by the sealing portion 30 along the edge of the exterior material 25, but is not limited thereto.

The exterior material 25 may include an upper exterior material 25a and a lower exterior material 25b. The upper exterior material 25a and the lower exterior material 25b may each have a multi-layered structure. The structures of the upper exterior material 25a and the lower exterior material 25b are the same as each other and thus hereinafter, an example will be described based on the upper exterior material 25a only. The upper exterior material 25a may have a configuration in which an external resin layer, a metal layer, and an internal resin layer are sequentially stacked.

As shown in FIG. 3, the sealing portion 30 may be on the edge of the exterior material 25, but is not limited thereto. Each insulating member 40 may be attached to each of the positive terminal 21 and the negative terminal 22, but is not limited thereto.

Positive Electrode

The description of the positive electrode is the same as described above.

Negative Electrode

The negative electrode for a rechargeable lithium battery includes a current collector and a negative electrode active material layer formed on the current collector and including a negative electrode active material.

The negative electrode active material may include a material that reversibly intercalates/deintercalates lithium ions, a lithium metal, a lithium metal alloy, a material capable of doping and dedoping lithium, and/or transition metal oxide.

The material that reversibly intercalates/deintercalates lithium ions may include, for example crystalline carbon, amorphous carbon, or a combination thereof as a carbon-based negative electrode active material. The crystalline carbon may be non-shaped, and/or sheet, flake, spherical, or fiber shaped natural graphite and/or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

In one or more embodiments, the negative electrode may include a carbon-based negative electrode active material, a silicon-based negative electrode active material, or a combination thereof as a negative electrode active material.

The material capable of doping/dedoping lithium may be a Si-based negative electrode active material and/or a Sn-based negative electrode active material. The Si-based negative electrode active material may include silicon, a silicon-carbon composite, SiOₓ (0<x<2), and/or a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, and/or a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one selected from the foregoing materials may be mixed together with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, and/or a polyimide resin. In this case, the content of silicon may be about 10 wt % to about 50 wt % based on the total weight of the silicon-carbon composite. In addition, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In addition, a thickness of the amorphous carbon coating layer may be about 5 nm to about 100 nm. An average particle diameter (D50) of the silicon particles may be about 10 nm to about 20 μm. The average particle diameter (D50) of the silicon particles may be, for example, about 10 nm to about 200 nm. The silicon particles may exist in an oxidized form, and in this case, an atomic content ratio of Si:O in the silicon particles indicating a degree of oxidation may be a weight ratio of about 99:1 to about 33:66. The silicon particles may be SiOₓ particles, and in this case, the range of x in SiOₓ may be greater than about 0 and less than about 2. In the present specification, unless otherwise defined, an average particle diameter (D50) indicates a diameter of particles having a cumulative volume of 50 volume % in the particle size distribution.

The Si-based negative electrode active material or Sn-based negative electrode active material may be mixed together with the carbon-based negative electrode active material. When the Si-based negative electrode active material or Sn-based negative electrode active material and the carbon-based negative electrode active material are mixed together and used, the mixing ratio may be a weight ratio of about 1:99 to about 90:10.

In the negative electrode active material layer, the negative electrode active material may be included in an amount of about 50 wt % to about 99 wt % based on the total weight of the negative electrode active material layer.

In one or more embodiments, the negative electrode active material layer further includes a binder, and may optionally further include a conductive material (e.g., an electrically conductive material). The content of the binder in the negative electrode active material layer may be about 1 wt % to about 5 wt % based on the total weight of the negative electrode active material layer. In addition, when the conductive material is further included, the negative electrode active material layer may include about 50 wt % to about 99 wt % of the negative electrode active material, about 1 wt % to about 5 wt % of the binder, and about 1 wt % to about 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

Examples of the water-insoluble binder include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder and/or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed together and used. As the alkali metal, Na, K and/or Li may be used. The amount of the thickener used may be about 0.1 parts by weight to about 3 parts by weight based on 100 parts by weight of the negative electrode active material.

The conductive material is included to provide electrode conductivity (e.g., electrical conductivity). Any suitable electrically conductive material may be used as a conductive material unless it causes a chemical change (e.g., an adverse chemical change) in a battery. Examples of the conductive material include a carbon-based material such as natural graphite, artificial graphite, carbon black, acetylene black, ketjen black, a carbon fiber, carbon nanotube, and the like; a metal-based material of a metal powder and/or a metal fiber including copper, nickel, aluminum silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

Separator

The separator separates a positive electrode and a negative electrode and provides a transporting passage for lithium ions and may be any suitable generally-used separator in a lithium ion battery. In other words, it may have low resistance to ion transport and excellent impregnation for an electrolyte. For example, separator may be selected from a glass fiber, polyester, TEFLON, polyethylene, polypropylene, polytetrafluoroethylene, or a combination thereof. It may have a form of a non-woven fabric or a woven fabric.

In order to secure heat resistance or mechanical strength, a separator coated with inorganic filler particles and/or an adhesive in a single-layer or multi-layer structure may be used.

For example, the coating layer of the separator may further include inorganic filler particles. The inorganic filler particles may be a metal oxide, a semi-metal oxide, or a combination thereof. For example, the inorganic filler particles may be one or more selected from alumina (Al₂O₃), boehmite, BaSO₄, MgO, Mg(OH)₂, clay, silica (SiO₂), and (TiO₂). The alumina, silica, and the like have a small particle size, and thus it is easy to make a dispersion.

For example, the inorganic filler particles may be Al₂O₃, SiO₂, TiO₂, SnO₂, CeO₂, NiO, CaO, ZnO, MgO, ZrO₂, Y₂O₃, SrTiO₃, BaTiO₃, MgF₂, Mg(OH)₂, or a combination thereof. The inorganic filler particles may have a sphere, plate shape, fiber shape, etc., but are not limited thereto, and any suitable form usable in the art may be used.

The plate-shaped inorganic filler particles include, for example, alumina and boehmite. In this case, a reduction in the area of the separator at a high temperature may be further suppressed or reduced, a relatively large degree of porosity may be secured, and characteristics may be improved when evaluating the penetration of a lithium battery.

When the inorganic filler particles are sheet-shaped or fiber-shaped, the inorganic filler particles may have an aspect ratio of about 1:5 to about 1:100. For example, the aspect ratio may be about 1:10 to about 1:100. For example, the aspect ratio may be about 1:5 to about 1:50. For example, the aspect ratio may be about 1:10 to about 1:50.

The sheet-shaped inorganic filler particles may have a length ratio of a major axis to a minor axis of about 1 to about 3 on a planar surface. For example, the length ratio of a major axis to a minor axis on the planar surface may be about 1 to about 2. For example, the length ratio of a major axis to a minor axis on the planar surface may be about 1. The aspect ratio and the length ratio of a major axis to a minor axis may be measured through a scanning electron microscope (SEM). Within the aspect ratio range and the length ratio range of a major axis to a minor axis, a separator may be suppressed from contraction, securing relatively improved porosity may be secured and improving penetration characteristics of a lithium battery.

When the inorganic filler particles are plate-shaped, a planar surface of the inorganic filler particles with one surface of a porous substrate has an average angle of about 0° to about 30°. For example, the average angle of the planar surface of the inorganic filler particles with one surface of a porous substrate may be converged to about 0°. In other words, the planar surface of the inorganic filler particles may be parallel (e.g., substantially parallel) with one surface of a porous substrate. For example, when the average angle of the planar surface of the inorganic filler particles with one surface of a porous substrate is within the ranges, the porous substrate may be effectively suppressed or reduced from thermal contraction, providing a separator with a reduced contraction rate.

On the other hand, the coating layer of the separator may include a particle-type or solution-type polymer adhesive as an adhesive. Examples of the polymer adhesive may include polyvinylidene fluoride (PVdF), a polyvinylidene fluoride-hexafluoropropylene (PVdF-HFP) copolymer, or a combination thereof. When a separator prepared by coating the polymer adhesive at least one surface of the substrate is used, the polymer adhesive is physically cross-linked with binders respectively present in the positive electrode and the negative electrode, improving adherence between the separator and the electrodes.

The coating layer may have thickness of about 1 μm to about 10 μm, or, for example, about 1 to about 8 μm. The coating layer having a thickness within the ranges may secure excellent heat resistance and in addition, suppress or reduce thermal contraction and elution of metal ions.

Electrolyte

The electrolyte includes a non-aqueous organic solvent and a lithium salt.

The non-aqueous organic solvent serves as a medium for transmitting ions taking part in the electrochemical reaction of a battery. The non-aqueous organic solvent may be a carbonate-based, ester-based, ether-based, ketone-based, or alcohol-based solvent, and/or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may be methyl acetate, ethyl acetate, n-propyl acetate, dimethyl acetate, methyl propionate, ethyl propionate, γ-butyrolactone, decanolide, valerolactone, mevalonolactone, caprolactone, and/or the like. The ether-based solvent may be dibutyl ether, tetraglyme, diglyme, dimethoxyethane, 2-methyltetrahydrofu ran, tetrahydrofuran, and/or the like and the ketone-based solvent may be cyclohexanone, and/or the like. In addition, the alcohol-based solvent may be ethyl alcohol, isopropyl alcohol, etc. and the aprotic solvent may be nitriles such as R-CN (where R is a C2 to C20 linear, branched, or cyclic hydrocarbon group and may include a double bond, an aromatic ring, or an ether bond), amides such as dimethylformamide, dioxolanes such as 1,3-dioxolane, sulfolanes, and/or the like.

The non-aqueous organic solvent may be used alone or in a mixture. When the organic solvent is used in a mixture, the mixture ratio may be controlled in accordance with a suitable or desirable battery performance.

In addition, in the case of the carbonate-based solvent, a mixture of a cyclic carbonate and a chain carbonate may be used. In this case, when the cyclic carbonate and the chain carbonate are mixed together in a volume ratio of about 1:1 to about 1:9, the electrolyte may exhibit excellent performance.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed together in a volume ratio of about 1:1 to about 30:1.

As the aromatic hydrocarbon-based solvent, an aromatic hydrocarbon-based compound represented by Chemical Formula I may be used.

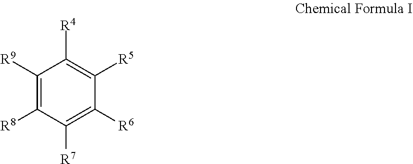

In Chemical Formula I, R⁴ to R⁹ are the same or different and are selected from hydrogen, a halogen, a C1 to C10 alkyl group, a haloalkyl group, and a combination thereof.

Examples of the aromatic hydrocarbon-based solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate and/or an ethylene carbonate-based compound of Chemical Formula II in order to improve cycle-life of a battery.

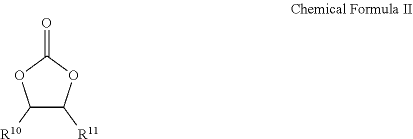

In Chemical Formula II, R¹⁰ and R¹¹ are the same or different, and are selected from hydrogen, a halogen, a cyano group, a nitro group, and fluorinated C1 to C5 alkyl group, provided that at least one selected from R¹⁰ and R¹¹ is selected from a halogen, a cyano group, a nitro group, and fluorinated C1 to C5 alkyl group, but both of R¹⁰ and R¹¹ are not hydrogen.

Examples of the ethylene-based carbonate-based compound may include difluoro ethylenecarbonate, chloroethylene carbonate, dichloroethylene carbonate, bromoethylene carbonate, dibromoethylene carbonate, nitroethylene carbonate, cyanoethylene carbonate, and/or fluoroethylene carbonate. The amount of the additive for improving cycle-life may be used within a suitable or appropriate range.

The lithium salt dissolved in the non-organic solvent supplies lithium ions in a battery, enables a basic operation of a rechargeable lithium battery, and improves transportation of the lithium ions between positive and negative electrodes.

Examples of the lithium salt may include at least one selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide): LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer in a range from 1 to 20, lithium difluoro(bisoxolato) phosphate, LiCl, Lil, LiB(C₂O₄)₂ (lithium bis(oxalato) borate: LiBOB), and lithium difluoro(oxalato)borate (LiDFOB).

The lithium salt may be used in a concentration in a range from about 0.1 M to about 2.0 M. When the lithium salt is included at the above concentration range, an electrolyte may have excellent performance and lithium ion mobility due to suitable or optimal electrolyte conductivity and viscosity.

In one or more embodiments, as an additive of the electrolyte, other additives may be further included in addition to the aforementioned compound.

The other additives may include at least one selected from vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), propenesultone (PST), propanesultone (PS), lithium tetrafluoroborate (LiBF₄), lithium difluorophosphate (LiPO₂F₂), and 2-fluorobiphenyl (2-FBP).

By further including the aforementioned other additives, cycle-life may be further improved, or gases generated from the positive electrode and the negative electrode may be effectively controlled when stored at a high temperature.

The other additives may be included in an amount of about 0.2 to about 20 parts by weight, about 0.2 to about 15 parts by weight, or, for example, about 0.2 to about 10 parts by weight, based on 100 parts by weight of the electrolyte for a rechargeable lithium battery.

When the content of other additives is as described above, the increase in film resistance may be minimized or reduced, thereby contributing to the improvement of battery performance.

Rechargeable lithium batteries may be classified as lithium ion batteries, lithium ion polymer batteries, and lithium polymer batteries according to the presence of a separator and the type (or kind) of electrolyte used therein. The rechargeable lithium batteries may have a variety of suitable shapes and sizes, and include cylindrical, prismatic, coin, and/or pouch-type batteries, and may be thin film batteries or may be rather bulky in size. Because the structure and manufacturing method of these batteries would be readily apparent to a person having ordinary skill in the art upon reviewing this disclosure, a detailed description thereof is not necessary and will not be provided here.

Hereinafter, examples of the present disclosure and comparative examples are described. It is to be understood, however, that the examples are for the purpose of illustration and are not to be construed as limiting the present disclosure.

### Example 1

(1) Manufacture of Positive Electrode

5 wt % of ZIF-8 as a metal organic framework, 90 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. This slurry was coated to be 164 μm thick on one surface of a 12 μm-thick aluminum current collector and then, dried and compressed, forming a positive electrode active material layer with a thickness of 138 μm. Herein, the positive electrode active material slurry was coated in a die coating method. After the coating, the coated current collector was primarily dried at 80° C. under an air atmosphere for 1 hour and vacuum-dried at 120° C. for 12 hours. The dried positive electrode plate was cut to have a size of 2×3 cm².

(2) Manufacture of Negative Electrode

A negative electrode active material slurry was prepared by mixing together 70 wt % of a negative electrode active material of artificial graphite (D50: 16.6 μm) and silicon (D50: 18.0 μm) in a weight ratio of 9:1, 15 wt % of a conductive material (Super-P), and 15 wt % of a binder (PAA (Poly Acrylic acid)) in water as a solvent.

The negative electrode active material slurry was coated to be 140 μm thick on one surface of a 10 μm thick copper foil and then, dried and compressed, forming a negative electrode having a total thickness of 120 μm. Herein, the negative electrode active material slurry was coated in a die coating method. After the coating, the coated current collector was primarily dried at 60° C. under an air atmosphere for 1 hour and at 110° C. under a vacuum condition for 12 hours. The dried negative electrode plate was cut to have a size of 2.2×3.2 cm².

(3) Battery Manufacture

A 14 μm-thick polyethylene/polypropylene/polyethylene separator was prepared and then, inserted between the negative electrode and the positive electrode. Herein, the separator was in contact with the coating surface (active material layer) of each electrode.

The electrode assembly was housed in a pouch, and an electrolyte prepared by mixing together ethylene carbonate and diethyl carbonate in a volume ratio of 30:70 and adding 1.5 M of a LiPF₆ lithium salt and 12.5 wt % of FEC thereto was injected thereinto, manufacturing a rechargeable lithium battery cell.

### Example 2

When manufacturing a positive electrode for a rechargeable lithium battery, MOF-177 was used instead of ZIF-8. Except for this change, a positive electrode for a rechargeable lithium battery and a rechargeable lithium battery cell of Example 2 were manufactured in substantially the same manner as in Example 1.

### Example 3

When manufacturing a positive electrode for a rechargeable lithium battery, HKUST-1 was used instead of ZIF-8. Except for this change, a positive electrode for a rechargeable lithium battery and a rechargeable lithium battery cell of Example 3 were manufactured in substantially the same manner as in Example 1.

### Example 4

When manufacturing a positive electrode for a rechargeable lithium battery, Fe-BTC was used instead of ZIF-8. Except for this change, a positive electrode for a rechargeable lithium battery and a rechargeable lithium battery cell of Example 3 were manufactured in substantially the same manner as in Example 1.

### Example 5

When manufacturing a positive electrode for a rechargeable lithium battery, each content of ZIF-8 and the positive electrode active material in the positive electrode active material layer was changed. Specifically, 0.05 wt % of ZIF-8 as a metal organic framework, 94.95 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. Except for this change, a positive electrode for a rechargeable lithium battery and a rechargeable lithium battery cell of Example 5 were manufactured in substantially the same manner as in Example 1.

### Example 6

When manufacturing a positive electrode for a rechargeable lithium battery, each content of ZIF-8 and the positive electrode active material in the positive electrode active material layer was changed. Specifically, 0.1 wt % of ZIF-8 as a metal organic framework, 94.9 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. Except for this change, a positive electrode for a rechargeable lithium battery and a rechargeable lithium battery cell of Example 6 were manufactured in substantially the same manner as in Example 1.

### Example 7

When manufacturing a positive electrode for a rechargeable lithium battery, each content of ZIF-8 and the positive electrode active material in the positive electrode active material layer was changed. Specifically, 1 wt % of ZIF-8 as a metal organic framework, 94 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. Except for this change, a positive electrode for a rechargeable lithium battery and a rechargeable lithium battery cell of Example 7 were manufactured in substantially the same manner as in Example 1.

### Example 8

When manufacturing a positive electrode for a rechargeable lithium battery, each content of ZIF-8 and the positive electrode active material in the positive electrode active material layer was changed. Specifically, 10 wt % of ZIF-8 as a metal organic framework, 85 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. Except for this change, a positive electrode for a rechargeable lithium battery and a rechargeable lithium battery cell of Example 8 were manufactured in substantially the same manner as in Example 1.

### Example 9

When manufacturing a positive electrode for a rechargeable lithium battery, each content of ZIF-8 and the positive electrode active material in the positive electrode active material layer was changed. Specifically, 20 wt % of ZIF-8 as a metal organic framework, 75 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. Except for this change, a positive electrode for a rechargeable lithium battery and a rechargeable lithium battery cell of Example 9 were manufactured in substantially the same manner as in Example 1.

### Example 10

When manufacturing a positive electrode for a rechargeable lithium battery, each content of ZIF-8 and the positive electrode active material in the positive electrode active material layer was changed. Specifically, 30 wt % of ZIF-8 as a metal organic framework, 65 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. Except for this change, a positive electrode for a rechargeable lithium battery and a rechargeable lithium battery cell of Example 10 were manufactured in substantially the same manner as in Example 1.

### Example 11

When manufacturing a positive electrode for a rechargeable lithium battery, each content of ZIF-8 and the positive electrode active material in the positive electrode active material layer was changed. Specifically, 40 wt % of ZIF-8 as a metal organic framework, 55 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. Except for this change, a positive electrode for a rechargeable lithium battery and a rechargeable lithium battery cell of Example 11 were manufactured in substantially the same manner as in Example 1.

### Comparative Example 1

When manufacturing a positive electrode for a rechargeable lithium battery, the metal organic framework was not used. Specifically, 95 wt % of LiNi_{0.91}Co_{0.07}Al_{0.02}O₂ as a positive electrode active material, 3 wt % of polyvinylidene fluoride as a binder, and 2 wt % of ketjen black as a conductive material were mixed together in an N-methylpyrrolidone solvent, preparing a positive electrode active material slurry. Except for this change, a positive electrode for a rechargeable lithium battery and a rechargeable lithium battery cell of Comparative Example 1 were manufactured in substantially the same manner as in Example 1.

### Comparative Example 2

When manufacturing a positive electrode for a rechargeable lithium battery, Ni-MOF-14 was used instead of ZIF-8. Except for this change, a positive electrode for a rechargeable lithium battery and a rechargeable lithium battery cell of Comparative Example 2 were manufactured in substantially the same manner as in Example 1.

Specifically, Ni-MOF-14 was Ni₃(BTB)₂(H-mlm)_{1.5}(H₂O)_{1.5} represented by Chemical Formula E, a coordination metal was Zn, and a linker was BTB (benzene-1,3,5-tribenzoate) and H-mlm (2-methylimidazole). The Ni-MOF-14 had a pore volume of 0.38 cm³/g and a BET specific surface area in a range of 700 to 900 m²/g.

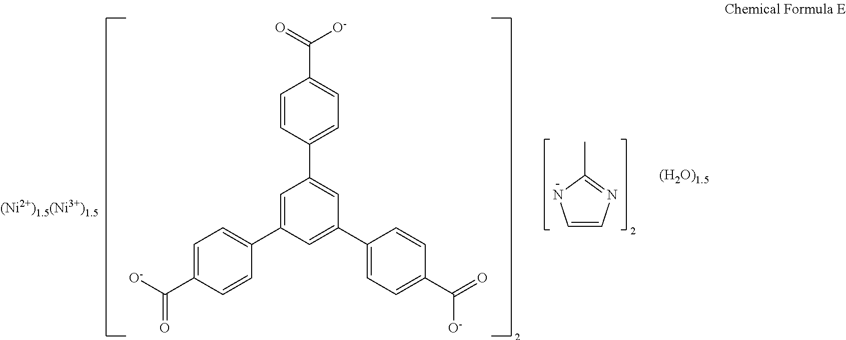

### Comparative Example 3

When manufacturing a positive electrode for a rechargeable lithium battery, Al-MIL-53 was used instead of ZIF-8. Except for this change, a positive electrode for a rechargeable lithium battery and a rechargeable lithium battery cell of Comparative Example 3 were manufactured in substantially the same manner as in Example 1.

Specifically, Al-MIL-53 was represented by Chemical Formula F, a coordination metal was Al, and a linker was terephthalic acid. The HKUST-1 had a pore volume of 0.7 g/cm³ and a BET specific surface area in a range of 1100 to 1500 m²/g.

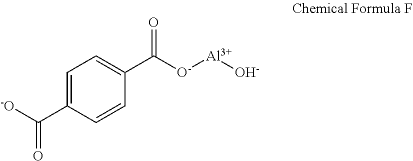

### Evaluation Example 1: Evaluation of the Amount of Gas Generated During Formation Charging and Discharging of the Rechargeable Lithium Battery Cells

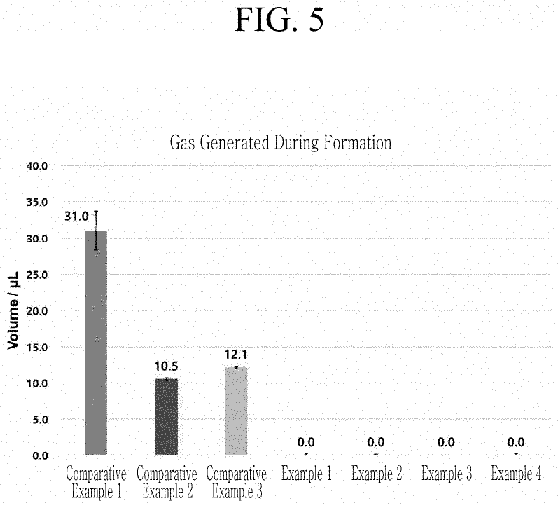

Each rechargeable lithium battery cell according to Examples 1 to 4 and Comparative Examples 1 to 3 were evaluated with respect to an amount of gas generated during the formation charging and discharging, and the results are shown in FIG. 5.

Specifically, the rechargeable lithium battery cells were once charged and discharged under the following condition at 25° C. (room temperature) to perform formation charging and discharging.
Charge condition: CC (constant current)/CV (constant voltage), 4.2 V, 0.02 C current cut-off
Discharge condition: CC (constant current), 2.5 V

When the formation charging and discharging was completed under the aforementioned condition, the rechargeable lithium battery cell was extracted with a syringe and injected into GC-MS to evaluate the amount of generated gas.

Referring to FIG. 5, the rechargeable lithium battery cell of Comparative Example 1 generated 31.0 μl of gas during the formation charging and discharging, the rechargeable lithium battery cells of Comparative Example 2 and 3 generated greater than or equal to 10.5 μl of gas during the formation charging and discharging, but the rechargeable lithium battery cells of Examples 1 to 4 generated a very insignificant amount of gas during the formation charging and discharging.

Accordingly, when the positive electrode for a rechargeable lithium battery according to one embodiment was inside a rechargeable lithium battery cell, an increase in a battery volume and an increase in an internal pressure of the rechargeable lithium battery cell was prevented or reduced by effectively trapping gas generated inside the rechargeable lithium battery cell during the first cycle charge and discharge (e.g., formation charging and discharging).

For example, ZIF-8, MOF-177, HKUST-1, and Fe-BTC used in the positive electrode for a rechargeable lithium battery according to one embodiment included Zn, Cu, or Fe as a coordination metal and thus exhibited an excellent gas trapping effect, compared with the metal organic framework including Ni or Al as a coordination metal.

Evaluation Example 2: Evaluation of the Amount of Gas Generated During Overcharging of the Rechargeable Lithium Battery Cells

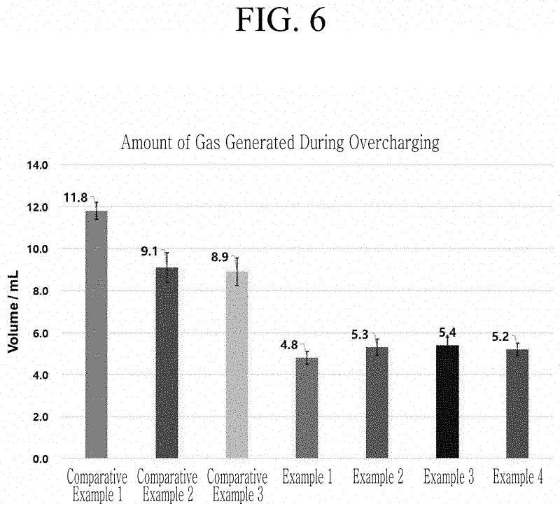

Each rechargeable lithium battery cell according to Examples 1 to 4 and Comparative Examples 1 to 3 was evaluated with respect to an amount of gas generated during the overcharge, and the results are shown in FIG. 6.

Specifically, the rechargeable lithium battery cells were overcharged to SOC (state of charge) of 500% at 25° C. (room temperature) for 5 hours.
Charge condition: CC (constant current) 1 C, 5 Hr. time cut-off

After completing the overcharge under the condition, the amount of generated gas was evaluated in substantially the same manner as in Evaluation Example 1.

Referring to FIG. 6, the rechargeable lithium battery cell of Comparative Example 1 generated 11.8 mL of gas during the overcharge, the rechargeable lithium battery cells of Comparative Examples 2 and 3 generated greater than or equal to 8.9 mL of gas during the overcharge, and the rechargeable lithium battery cells of Examples 1 to 4 generated less than 50% of the gas, which was generated by the rechargeable lithium battery cell of Comparative Example 1.

Accordingly, when the positive electrode for a rechargeable lithium battery according to one embodiment was inside a rechargeable lithium battery cell, an increase in a battery volume and an increase in an internal pressure of the rechargeable lithium battery cell was prevented or reduced by effectively trapping gas generated inside the rechargeable lithium battery cell.

On the other hand, the rechargeable lithium battery cells according to Examples 1 to 4, Example 1 using a positive electrode for a rechargeable lithium battery including ZIF-8 as MOF exhibited a significantly reduced amount of generated gas. According to MOF-related literature (Hasmukh A. Patel et. al., ChemSusChem 2017, 10, 1303 to 1317), cations such as zinc ions and the like increased polarity and thus increased a reaction area for gas adsorption, and anions such as an imidazole skeleton and the like provide lone pairs of electrons and thus increase chemical adsorption of gas molecules. On the surface of MOF pores, chemical adsorption of gas molecules by cations/anions and physical adsorption of carbon and the like in a nonpolar region occur, but the farther away from the pore surface, the more the physical adsorption rather than the chemical adsorption occurs due to Van der Waals attraction between the gas molecules. Accordingly, when three factors such as a binding force of the cations/anions to the gas molecules, a surface area of a material, and a size of the pores are maximized or increased, gas adsorption capacity may be maximized or increased. ZIF-8 exhibited the greatest gas reduction effect and thus was estimated to have a structure of maximizing or increasing this effect to the gas components generated in the rechargeable lithium battery cell,

### Evaluation Example 3: Evaluation of the Amount of Gas Generated During Heat Exposure of the Rechargeable Lithium Battery Cells

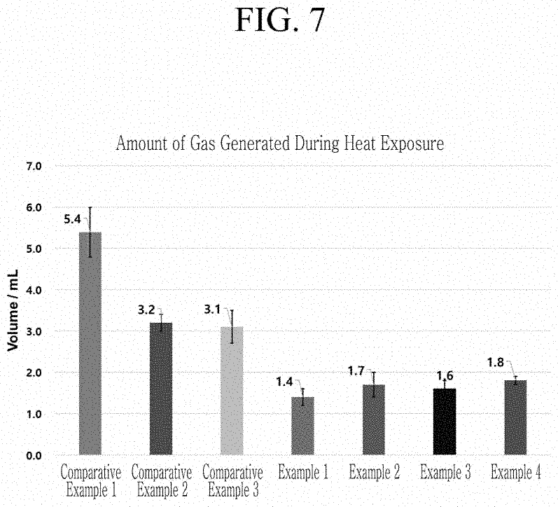

Each rechargeable lithium battery cell according to Examples 1 to 4 and Comparative Examples 1 to 3 were evaluated with respect to an amount of gas generated during the heat exposure, and the results are shown in FIG. 7.

Specifically, the rechargeable lithium battery cells were charged at 4.2 V and cut off at a current of 0.02 C, heat-treated to 140° C. at 5° C./min, and allowed to stand at 140° C. for 1 hour.

After overcharging the cells under the above condition, the cells were evaluated with respect to an amount of gas generated in the same method as in Evaluation Example 1.

Referring to FIG. 7, the rechargeable lithium battery cell of Comparative Example 1 generated gas of 5.4 mL during the heat exposure, and the rechargeable lithium battery cells of Comparative Examples 2 and 3 generated gas of greater than or equal to 3.1 mL during the heat exposure, but the rechargeable lithium battery cells of Examples 1 to 4 generated less than 50% of gas of Comparative Example 1 during the heat exposure at 140° C.

Accordingly, when the positive electrode for a rechargeable lithium battery according to one embodiment was inside the rechargeable lithium battery cell, an increase in battery volume and an increase in internal pressure of the rechargeable lithium battery cell was prevented or reduced by effectively trapping gas generated inside the rechargeable lithium battery cell even in a heat exposure situation.

On the other hand, among the rechargeable lithium battery cells of Examples 1 to 4, the cell of Example 1 using a positive electrode for a rechargeable lithium battery including ZIF-8 exhibited a significantly reduced amount of generated gas, which is consistent with Evaluation Example 2.

### Evaluation Example 4: Evaluation of the Amount of Gas Generated According to the Content of Metal Organic Framework in the Positive Electrode Active Material Layer

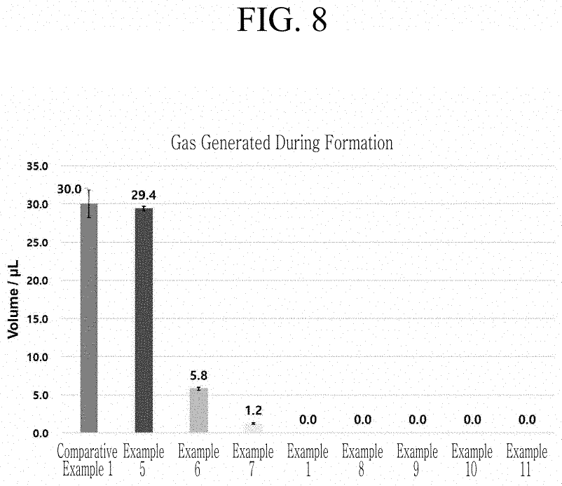

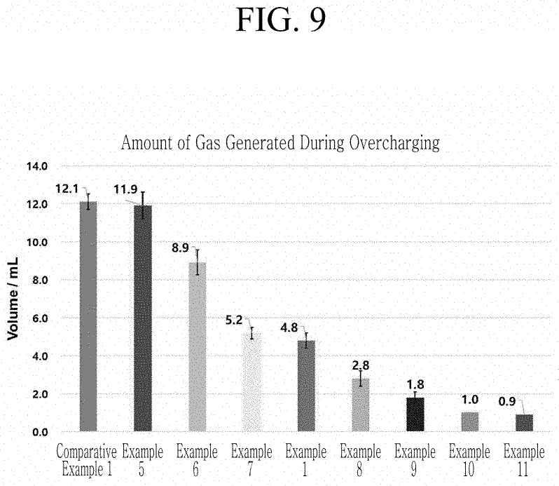

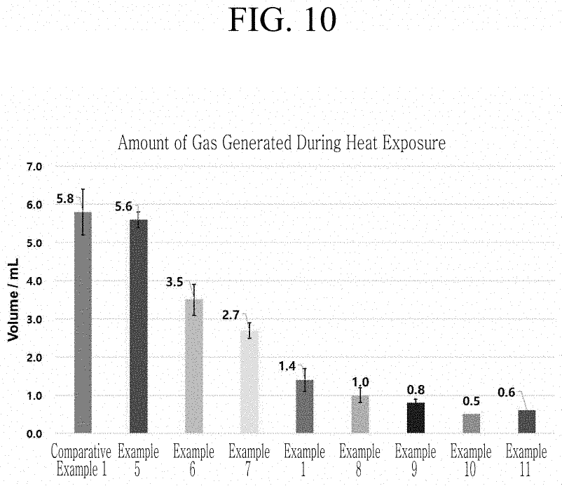

Each rechargeable lithium battery cell of Examples 1 and 5 to 11 and Comparative Example 1 was evaluated with respect to an amount of gas generated during formation charge, overcharge, and heat exposure, which were respectively provided in FIG. 8 (formation charging and discharging), FIG. 9 (overcharge), and FIG. 10 (heat exposure).

Herein, the formation charging and discharging condition was the same as in Evaluation Example 1, the overcharge was performed under the same condition as in Evaluation Example 2, and the heat exposure was performed under the same condition as in Evaluation Example 3, and the amount of generated gas was evaluated in the same method as in Evaluation Examples 1 to 3.

Referring to FIGS. 8 to 10, even though the same metal organic framework was used, an amount of gas generated during the formation charging and discharging, the overcharge, and the heat exposure was changed according to a content of the metal organic framework in a positive electrode active material layer.

Accordingly, the content of the metal organic framework in a positive electrode active material layer was adjusted to control the amount of gas generated during the formation charging and discharging, the overcharge, and the heat exposure.

While this disclosure has been described in connection with what is presently considered to be practical example embodiments, it is to be understood that the present disclosure is not limited to the disclosed embodiments. On the contrary, it is intended to cover various modifications and equivalent arrangements included within the spirit and scope of the appended claims, and equivalents thereof.

Description of Symbols

| | |
|---|---|
| 100: rechargeable lithium battery | 112: negative electrode |
| 113: separator | 114: positive electrode |
| 120: battery case | 140: sealing member |

What is claimed is:

1. A positive electrode for a rechargeable lithium battery, comprising:
a positive electrode current collector and a positive electrode active material layer on one surface or two opposing surfaces of the positive electrode current collector,
wherein the positive electrode active material layer comprises:
a metal organic framework (MOF) of ZIF-8, MOF-177, HKUST-1, Fe-BTC, or a combination thereof; and
a positive electrode active material that is a nickel-based oxide.

2. The positive electrode of claim 1, wherein:
the positive electrode active material that is the nickel-based oxide comprises a lithium composite oxide represented by Chemical Formula 1:
LiₐNiₓM¹_{y}M²_{z}O_{2+b} Chemical Formula 1
wherein, in Chemical Formula 1, 0.9≤a≤1.3, 0.3≤x≤1, 0≤y≤0.7, 0≤z≤0.1, x+y+z=1, M¹ is at least one element selected from Co, Mn, or Al, and M² is at least one element selected from Al, B, Ce, Co, Cr, F, Mg, Mn, Mo, Nb, P, S, Ti, V, W, or Zr.

3. The positive electrode of claim 2, wherein:
the positive electrode active material that is the nickel-based oxide includes
an NCM-based positive electrode active material wherein, in Chemical Formula 1, M¹ includes Co and Mn; M² is at least one element selected from Al, B, Ce, Cr, F, Mg, Mo, Nb, P, S, Ti, V, W, or Zr; 0.9≤a≤1.3; 0.7≤x≤1; 0<y≤0.3, and 0≤z≤0.1,
an NCA-based positive electrode active material wherein, in Chemical Formula 1, M¹ includes Co and Al; M² is at least one element selected from B, Ce, Cr, F, Mg, Mn, Mo, Nb, P, S, Ti, V, W, or Zr; 0.9≤a≤1.3; 0.7≤x≤1; 0<y≤0.3, and 0≤z≤0.1,
an NiMn-based positive electrode active material wherein, in Chemical Formula 1, M¹ includes Mn; M² is at least one element selected from Al, B, Ce, Cr, F, Mg, Mo, Nb, P, S, Ti, V, W, or Zr; 0.9≤a≤1.3; 0.5≤x≤1; 0<y≤0.5; and 0≤z≤0.1, or a combination thereof.

4. The positive electrode of claim 1, wherein:
a content of the metal organic framework based on the total amount of the positive electrode active material layer is about 0.1 wt % to about 40 wt %.

5. The positive electrode of claim 1, wherein:
a content of the positive electrode active material based on the total amount of the positive electrode active material layer is about 55 wt % to about 98 wt %.

6. The positive electrode of claim 1, wherein:
the positive electrode active material layer further comprises a binder, a conductive material, or a combination thereof.

7. The positive electrode of claim 6, wherein:
the metal organic framework is included in an amount of about 0.05 wt % to about 40 wt %, the positive electrode active material is included in an amount of about 55 wt % to about 98 wt %, the binder is included in an amount of about 1 wt % to about 5 wt %, and the conductive material is included in an amount of about 1 wt % to about 5 wt % based on the total amount of the positive electrode active material layer.

8. The positive electrode of claim 1, wherein:
a thickness of the positive electrode active material layer is about 1 μm to about 200 μm.

9. The positive electrode of claim 1, wherein:
a loading amount of the positive electrode active material layer is about 1 mg/cm² to about 80 mg/cm² per area of one surface of the positive electrode current collector.

10. The positive electrode of claim 1, wherein:
the positive electrode active material layer is patterned in the form of a plurality of circles, stripes, rings, or a combination thereof.

11. A rechargeable lithium battery comprising the positive electrode for a rechargeable lithium battery of claim 1.

12. The rechargeable lithium battery of claim 11, wherein:
the rechargeable lithium battery comprises an assembly in which the positive electrode for a rechargeable lithium battery; a separator; and a negative electrode are sequentially stacked.
